(19) United States
(12) Patent Application Publication
(10) Pub. No.: US 2023/0039724 A1
(43) Pub. Date: Feb. 9, 2023

(54) SCRATCH PANEL

(71) Applicant: Patrick Howard, JR., North Clarendon, VT (US)

(72) Inventor: Patrick Howard, JR., North Clarendon, VT (US)

(21) Appl. No.: 17/397,524

(22) Filed: Aug. 9, 2021

(51) Int. Cl. A61H 7/00; A61H 11/00

(52) U.S. Cl. CPC A61H 7/003; A61H 7/005; A61H 11/00; A61H 2201/0192; A61H 2201/1692; A61H 2201/0153; A61H 2201/0126; A61H 2201/0138; A61H 2201/105; A61H 2201/1215

(57) ABSTRACT

The scratch panel is a wall-mounting panel to relieve itching in particularly difficult to reach locations, such as the back. It utilizes artificial turf and sand paper like textured surfaces upon which the body may be scratched. Since the panel is wall-mounted, no hands are necessary to relieve bothersome itches. The panel holds adjustable rollers that stretch the artificial turf and allow recycling of the surface. The adjustable rollers allow the user to use different parts of the turf and replace said turf when necessary. The disclosed device includes a scrollable abrasive material stretched across a first scroll and a second scroll wherein the scrolls each lock to fix the scrollable abrasive material in a fixed relation thereto. A holder receives the scrolls in a rotating relation and provides a grip for a user and defines mounting holes to a wall or a piece of furniture.

### BACKGROUND

Itch is a sensation that causes the desire or reflex to scratch. Itch has resisted many attempts to be classified as any one type of sensory experience. Itch has many similarities to pain, and while both are unpleasant sensory experiences, their behavioral response patterns are different. Pain creates a withdrawal reflex, whereas itch leads to a scratch reflex. There have been no products available as original equipment or as an aftermarket to address this problem.

Oftentimes people have an itch on a part of their body which is difficult to reach. This is a problem that can be solved in a variety of ways, with differing effectiveness. Regardless of the exact solution, a textured object must come in contact with the bodily location to relieve the itch. There have been no products available as original equipment or as an aftermarket to address this problem either.

There exists a need for a scratch device that is not being met by any known or disclosed device or system of present.

### SUMMARY OF THE INVENTION

The scratch panel is a wall-mounting panel to relieve itching in particularly difficult to reach locations, such as the back. The scratch panel utilizes artificial turf and sand paper like scrolling material to be the textured surface upon which the body may be scratched. Since the panel is wall-mounted, no hands are necessary to relieve bothersome itches. The panel holds adjustable rollers that stretch the artificial turf or sand paper, etc. The adjustable rollers allow the user to use different parts of the turf and sand paper and replace said turf when necessary.

A scratching device as disclosed includes a scrollable abrasive material stretched across a first scroll and a second scroll wherein the scrolls each lock to fix the scrollable abrasive material in a fixed relation thereto. A holder of the first and the second scrolls receives the scrolls in a rotating relation and provides a grip for a user and defines mounting holes to a wall or a piece of furniture.

### BRIEF DESCRIPTION OF THE DRAWINGS

FIG. 1 is an exploded view of the various components of the artificial turf scratch panel in accordance with an embodiment of the present disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

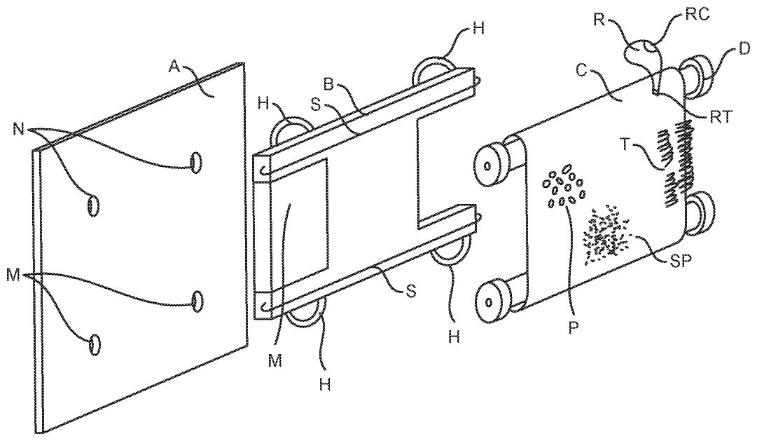

FIG. 1 is an exploded view of the various components of the artificial turf scratch panel in accordance with an embodiment of the present disclosure. There is a square-shaped metal plate A that attaches to the wall and holds the rollers D for the scratching surface C. A metal H-shaped piece B holds the rollers to the metal plate. Also depicted are the reservoir R, the reservoir cap RC and the reservoir tip RT. A motor M is attached in embodiments to turn the first and second scrolls D and thereby move the scrollable abrasive material C. Shafts S are wire like and rod like and are attached to the holder B for insertion through the scrolls for a rotation there around. The mounting holes N are defined in the holder B for mounting via fastening hardware to a wall or to a piece of furniture. Handles H are provided for manual placement of the device against any part of a user's body. The surface of the scrollable abrasive material includes a sandpaper like portion SP, a bristles or astro turf like portion and a bumpy portion P as depicted or in sheets, stripes on the sheets or on horizontal bars in a parallel relation to the scrolls for the holder “H” on its side. Embodiments include the holder in a conventional “H” orientation.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

While the forgoing examples are illustrative of the principles of the present disclosure in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the disclosure be limited, except as by the specification and claims set forth herein.

What is claimed is:

1. A scratching device comprising:
a scrollable abrasive material;
a first scroll and a second scroll wherein the scrolls each lock to fix the scrollable abrasive material in a fixed relation thereto; and
a holder of the first and the second scrolls wherein the holder receives the scrolls in a rotating relation and provides a grip for a user and defines mounting holes.

2. The scratching device of claim 1, wherein the scrollable abrasive material is an artificial turf.

3. The scratching device of claim 1, wherein the scrollable abrasive material is a sand paper.

4. The scratching device of claim 1, wherein the first scroll and the second scroll each comprise knurled circumference to enable a torquing thereof.

5. The scratching device of claim 1, wherein the holder is shaped like an “H” wherein extremities thereof receive a knob of the first and the second scrolls.

6. The scratching device of claim 1, wherein a clockwise turn of the first scroll brings about a clockwise turn of the second scroll via the scrollable abrasive material.

7. The scratching device of claim 1, wherein the holder comprises raised bumpy portions configured to cause the scrollable abrasive material to present corresponding raised bumpy portions to a user's back.

8. The scratching device of claim 1, wherein the holder is mountable to a wall or a piece of furniture via a wall and furniture fastener.

9. The scratching device of claim 1, further comprising a motor to rotate at least one of the scrolls and present a moving scratching surface to a user.

10. The scratching device of claim 1, wherein the first scroll and the second scroll lock in place via a ratchet on each of the first and the second scroll.

11. The scratching device of claim 1, wherein the grip on the holder is a pair of handles for a user's hands.

12. The scratching device of claim 1, wherein the first and the second scroll rotate in relation to each other to move the scrollable abrasive material vertically.

13. The scratching device of claim 1, wherein the first and the second scroll rotate in relation to each other to move the scrollable abrasive material horizontally.

14. The scratching device of claim 1, further comprising a reservoir for a washing and lubricating fluid to egress onto the scrollable abrasive material.

15. The scratching device of claim 1, further comprising a reservoir for a washing fluid to egress therefrom onto the scrollable abrasive material based on movement of the scrollable abrasive material.

16. The scratching device of claim 1, further comprising a reservoir for a washing fluid to egress therefrom onto the scrollable abrasive material based on a rotation of the first and the second scrolls.

17. The scratching device of claim 1, further comprising a reservoir for a lotion fluid to egress therefrom onto the scrollable abrasive material based on the scrollable abrasive material moving an egress orifice of the reservoir which is normally closed.

18. The scratching device of claim 1, wherein the first scroll and the second scroll lock into place via setting into the holder and rotate via a release from the holder.

19. The scratching device of claim 1, wherein the first scroll and the second scroll each rotate on a respective shaft attached to the holder.

20. The scratching device of claim 1, wherein the first scroll and the second scroll each rotate on a respective boss attached to the holder.
